(19) United States
(12) Patent Application Publication
(10) Pub. No.: US 2017/0274516 A1
(43) Pub. Date: Sep. 28, 2017

(54) HYDRAULIC BREAKER

(71) Applicant: AY HEAVY INDUSTRIES, Suwon-si Gyeonggi-do (KR)

(72) Inventor: Sung Wook JEON, Suwon-si Gyeonggi-do (KR)

(73) Assignee: AY HEAVY INDUSTRIES

(21) Appl. No.: 15/618,124

(22) Filed: Jun. 9, 2017

Related U.S. Application Data
(63) Continuation of application No. PCT/KR2015/014350, filed on Dec. 28, 2015.

(30) Foreign Application Priority Data
Jan. 7, 2015 (KR) 10-2015-0001775

(51) Int. Cl. B25D 9/14; E02F 5/30; E02F 3/96; B25D 9/04

(52) U.S. Cl. CPC B25D 9/145; B25D 9/04; E02F 5/305; E02F 3/966; B25D 2209/002; B25D 2250/125

(57) ABSTRACT

The present invention relates to a hydraulic breaker comprising: a back head having a gas chamber provided therein; a cylinder disposed at the lower part of the back head, and having a hydraulic passage and a hydraulic space; a front head disposed at the lower part of the cylinder; a chisel provided inside the front head; a piston provided to reciprocate in the cylinder so as to hit the chisel; and a breaker main body having a plurality of penetration bolts integrally connecting the back head, the cylinder, and the front head, wherein the back head of the breaker main body is provided with a control valve for supplying and blocking hydraulic pressure to/from the hydraulic passage and the hydraulic space.

### CROSS-REFERENCES TO RELATED APPLICATIONS

This Application claims the benefit of priority and is a Continuation application of the prior International Patent Application No. PCT/KR2015/014350, with an international filing date of Dec. 28, 2015, which designated the United States, and is related to the Korean Patent Application No. 10-2015-0001775, filed Jan. 7, 2015, the entire disclosures of all applications are expressly incorporated by reference in their entirety herein.

### BACKGROUND OF THE INVENTION

### 1. Field of the Invention

The present invention relates to a hydraulic breaker, and more particularly, to a hydraulic breaker in which a control valve of a breaker main body has an improved installation structure.

### 2. Description of Related Art

Generally, hydraulic breakers are widely used to break rocks, concrete, and the like by being installed at excavators, which are construction machines.

A breaker main body of such a conventional hydraulic breaker is illustrated in FIG. 5. As illustrated in FIG. 5, a breaker main body 110 of a conventional hydraulic breaker includes a back head 111 provided with a gas chamber 113 therein, a cylinder 121 disposed below the back head 111 and provided with a hydraulic path 123 and a hydraulic space 125, a front head 131 disposed below the cylinder 121, a chisel 135 installed inside the front head 131, and a piston 141 reciprocally movably installed in the cylinder 121 so as to strike the chisel 135.

In addition, the back head 111, the cylinder 121, and the front head 131 are hermetically connected to each other by a plurality of through bolts 145.

In addition, the cylinder 121 is provided, on an inner side thereof, with a control valve 151 to supply hydraulic pressure to the hydraulic path 123 and the hydraulic space 125 of the cylinder 121 and operate the piston 141, and the cylinder 121 is provided, on an outer side thereof, with an accumulator 155 to smooth flow of a fluid through the hydraulic path 123. In particular, the control valve 151 frequently breaks down due to frequent hydraulic interruption.

However, in the breaker main body 110 of a conventional hydraulic breaker, the control valve 151 is installed on the inner side of the cylinder 121 below the back head 111, and thus, when the control valve 151 breaks down, the through bolts 145 are unfastened, the control valve 151 is replaced after disassembly of the back head 111, the cylinder 121, and the front head 131, and then the back head 111, the cylinder 121, and the front head 131 are fastened again with the through bolts 145 to reassemble these elements. Thus, replacement of the control valve 151 is inconvenient and takes a long time, resulting in reduced productivity.

In addition, a conventional hydraulic breaker includes a bracket that surrounds and supports the breaker main body and is installed in an excavator.

Such a hydraulic breaker equipped with a bracket is disclosed in Korean Registered Utility Model No. 20-0340958.

As disclosed in the prior art, in the bracket of a conventional hydraulic breaker, a lower end portion of a breaker main body inserted into the bracket is fixed to the bracket by a fixing member, and the three remaining surfaces except for the front surface of an upper end portion of the breaker main body are supported by the bracket by a fixing pad.

In addition, a support member assembly, including a support piece, a support member, a movement prevention member, and a pad, is provided between the front surface of the breaker main body and the inside of the bracket.

The support pieces are separated from each other on opposite sides of an upper end front surface portion of the inside of the bracket to be welded or protrude in an integrated manner.

The support member is in surface contact with an inner side surface of the bracket while being caught by the support pieces, is provided with a fixing pin protruding from an upper outer side surface thereof, and is provided with an insertion hole in a surface thereof contacting the main body.

The movement prevention member is fitted to the fixing pin of the support member to prevent vertical movement, and the pad is inserted into and coupled to the insertion hole.

However, the bracket of a conventional hydraulic breaker has a tube welding structure, and thus the support member assembly is loosely assembled between the front surface of the breaker main body and the inside of the bracket. Accordingly, the support member moves upward, downward, leftward, or rightward, and thus the breaker main body is not satisfactorily fixed, resulting in occurrence of loud noise during operation and reduced work efficiency.

### BRIEF SUMMARY OF THE INVENTION

Therefore, the present invention has been made in view of the above problems, and it is one object of the present invention to provide a hydraulic breaker including a conveniently replaceable control valve and having enhanced productivity due to shortened replacement time.

It is another object of the present invention to provide a hydraulic breaker in which a breaker main body is stably supported by a bracket, resulting in reduced noise during operation and enhanced work efficiency.

The above and other objects can be accomplished by the present disclosure described below.

In accordance with one aspect of the present invention, provided is a hydraulic breaker including a breaker main body including: a back head provided with a gas chamber therein; a cylinder positioned below the back head and provided with a hydraulic path and a hydraulic space; a front head positioned below the cylinder; a chisel installed inside the front head; a piston reciprocally movably installed in the cylinder so as to strike the chisel; and a plurality of through bolts connecting the back head to the cylinder to the front head, wherein the back head of the breaker main body is provided with a control valve to supply hydraulic pressure to the hydraulic path and the hydraulic space and block the supply.

In this regard, the cylinder may be provided, on an outer side thereof, with an accumulator to smooth flow of a fluid through the hydraulic path.

The hydraulic breaker may include a bracket surrounding and supporting the breaker main body and installed at an excavator, a lower end portion of the breaker main body inserted into the bracket being fixed to the bracket by a fixing member, and three remaining surfaces except for a front surface of an upper end portion of the breaker main body being supported by the bracket by a fixing pad; a stopper provided at an inner upper end portion of the bracket facing the front surface of the breaker main body and having a tapered portion where a distance between the front surface of the breaker main body and an inside of the bracket gradually decreases towards a lower end portion of the bracket; and a support member assembly having a closely contacting inclined portion that closely contacts the tapered portion and disposed between the stopper and the front surface of the breaker main body to support the front surface of the upper end portion of the breaker main body on the inside of the bracket.

The support member assembly may include a fixture provided with the closely contacting inclined portion closely contacting the tapered portion, an insertion hole formed in a plate surface thereof facing the front surface of the breaker main body, and a fixing pin protruding from an upper portion thereof, and inserted between the stopper and the front surface of the breaker main body; a movement prevention member fitted into and coupled to the fixing pin to prevent vertical movement; and a shock absorption pad inserted into and coupled to the insertion hole to absorb shock.

As is apparent from the foregoing description, a control valve is installed at a back head of a breaker main body, and thus the control valve may be conveniently replaced and productivity may be enhanced due to shortened replacement time.

In addition, a bracket has an improved support structure for the breaker main body, and thus the breaker main body is stably supported by the bracket, resulting in reduced occurrence of noise during operation and enhanced work efficiency.

### BRIEF DESCRIPTION OF THE DRAWINGS

FIG. 1 is a broken perspective view of an essential part of a breaker main body of a hydraulic breaker according to the present invention.

FIG. 2 is a cross-sectional view of FIG. 1.

FIG. 3 is a cross-sectional view illustrating an assembled state of a breaker main body and a bracket of a hydraulic breaker according to the present invention.

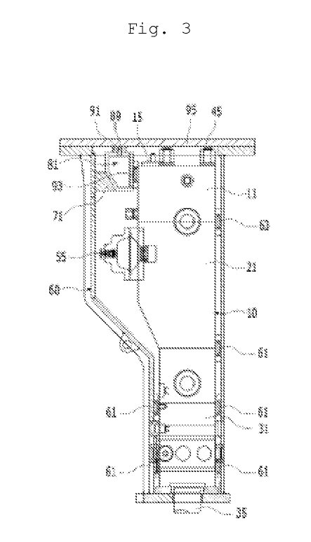

FIG. 4 is an exploded perspective view illustrating an essential part of a support member assembly and a stopper of FIG. 3.

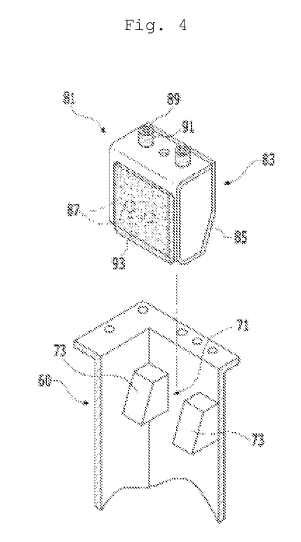

FIG. 5 is a broken perspective view illustrating an essential part of a breaker main body of a conventional hydraulic breaker.

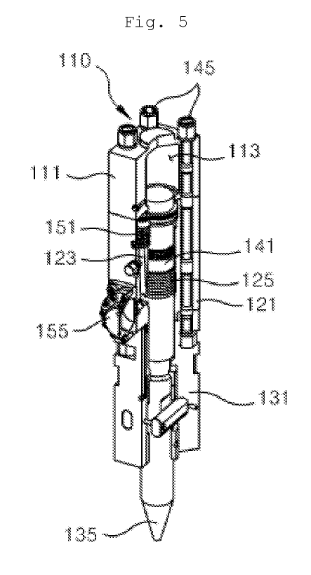

### DETAILED DESCRIPTION OF THE INVENTION

Hereinafter, the present invention will be described in detail with reference to the accompanying drawings.

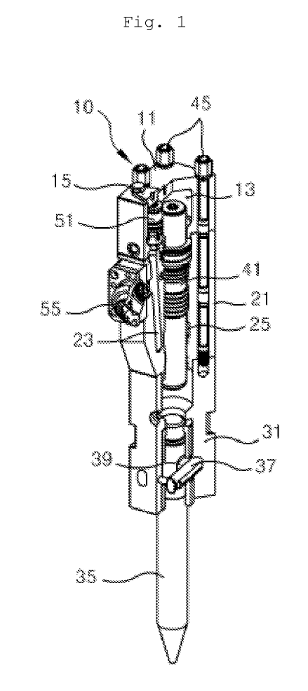

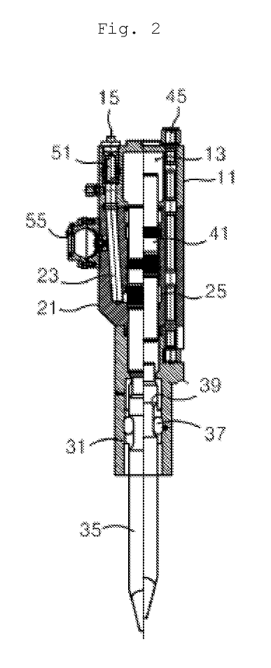

FIGS. 1 and 2 illustrate a breaker main body of a hydraulic breaker according to the present invention.

As illustrated in the drawings, the breaker main body 10 of a hydraulic breaker according to the present invention includes a back head 11, a cylinder 21, a front head 31, a chisel 35, and a piston 41. In this regard, to aid in understanding of an operation of the breaker main body 10, a left side cross-sectional view of FIG. 2 illustrates a state in which the chisel 35 of the breaker main body 10 is lowered, and a right side cross-sectional view of FIG. 2 illustrates a state in which the chisel 35 is raised.

The back head 11 is provided with a gas chamber 13 therein, and is positioned at the uppermost end of the breaker main body 10. The back head 11 is provided with a control valve 51 detachably, which will be described below, and is provided with a valve cover 15 to cover the control valve 51.

The cylinder 21 is positioned below the back head 11, and is provided with a hydraulic path 23 and a hydraulic space 25.

The front head 31 is positioned below the cylinder 21.

The back head 11, the cylinder 21, and the front head 31 are hermetically connected to one another by a plurality of through bolts 45, and thus the breaker main body 10 forms an overall rectangular cylindrical appearance.

The chisel 35 is installed inside the front head 31 to be struck by the piston 41 to break rocks, concrete, and the like. The chisel 35 can ascend or descend within a chisel groove 39 having an elongated hole shape and formed in the chisel 35, in a state of being supported by a chisel pin 37.

The piston 41 is reciprocally movably installed in the hydraulic space 25 of the cylinder 21 so as to strike the chisel 35. The piston 41 reciprocates in the hydraulic space 25 of the cylinder 21 by hydraulic interruption of the control valve 51.

The control valve 51 is detachably in the back head 11 of the breaker main body 10, and is covered by the valve cover 15 provided in the back head 11. The control valve 51 supplies hydraulic pressure to the hydraulic path 23 and the hydraulic space 25 of the cylinder 21 and blocks the supply.

As such, by installing the control valve 51 in the back head 11 of the breaker main body 10, the control valve 51 may be conveniently replaced, and productivity may be enhanced due to shortened replacement time.

That is, in the breaker main body 10 of the hydraulic breaker according to the present invention, when the control valve 51 breaks down, the through bolts 45 integrally connecting the back head 11 to the cylinder 21 to the front head 31 do not need to be unfastened, and only the control valve 51 installed in the back head 11 may be conveniently replaced after being disassembled.

In addition, the breaker main body 10 of the hydraulic breaker according to the present invention includes an accumulator 55. The accumulator 55 is provided at an outer side of the cylinder 21 to smooth flow of a fluid through the hydraulic path 23. For example, when a fluid is not supplied to the hydraulic space 25 due to rapid operation of the control valve 51 that supplies hydraulic pressure, smooth supply conditions may be maintained by the accumulator 55.

The hydraulic breaker according to the present invention includes a bracket 60 that surrounds and supports the breaker main body 10, and is installed at an excavator (not shown).

The bracket 60 has a cylindrical shape with openings at opposite sides thereof, and an upper end portion of the bracket 60 has a larger cross-sectional shape than that of a lower end portion thereof to prevent the breaker main body 10 from interfering with the accumulator 55.

A lower end portion of the breaker main body 10 inserted into the bracket 60 is fixed to the bracket 60 by a fixing member 61, and the three remaining surfaces except for a front surface of an upper end portion of the breaker main body 10 are supported by the bracket 60 by a fixing pad 63.

The front surface of the breaker main body 10 and an inner upper end portion of the bracket 60 facing the front surface of the breaker main body 10 are supported by a stopper 71 and a support member assembly 81.

The stopper 71 is configured in pairs, and is fixed by welding or the like to the inner upper end portion of the bracket 60 facing the front surface of the breaker main body 10, with a gap therebetween. In addition, each stopper 71 has a tapered portion 73 where a distance between the front surface of the breaker main body 10 and the inside of the bracket 60 gradually decreases towards a lower end portion of the bracket 60. In the present embodiment, the stopper 71 is configured in pairs, but the present invention is not limited thereto, and a single stopper 71 may be provided.

The support member assembly 81 is disposed between the stopper 71 and the front surface of the breaker main body 10 to support the front surface of the upper end portion of the breaker main body 10 on the inside of the bracket 60. The support member assembly 81 includes a fixture 83, a movement prevention member 91, and a shock absorption pad 93.

The fixture 83 is provided, on one side thereof, with a closely contacting inclined portion 85 that is inclined with respect to the stopper 71 and closely contacts the tapered portion 73 of the stopper 71, and has a rectangular cylindrical shape. An insertion hole 87 to which the shock absorption pad 93 is coupled is formed in a plate surface of a main body of the fixture 83 facing the front surface of the breaker main body 10. In addition, the fixture 83 is provided with a pair of fixing pins 89 protruding from an upper surface thereof, with a gap therebetween.

The movement prevention member 91 has an annular shape, is made of a rubber material, and is fitted into and coupled to the fixing pins 89 to prevent vertical movement, for example, longitudinal movement, of the breaker main body 10. In this regard, the movement prevention member 91 may be longer than the fixing pins 89.

The shock absorption pad 93 has a plate shape, is made of a rubber material, and is inserted into and coupled to the insertion hole 87 of the fixture 83 to absorb shock between the front surface of the breaker main body 10 and the inside of the bracket 60.

In this case, reference numeral 95, which has not been described, denotes a head plate, and the head plate 95 blocks an upper opening of the bracket 60.

By such configuration, a process of assembling the breaker main body 10 and the bracket 60 will be described briefly as follows.

When the breaker main body 10 is inserted into the bracket 60 towards a lower part of the bracket 60 from an upper part thereof, the lower end portion of the breaker main body 10 is fixed to the bracket 60 by the fixing member 61, and the three remaining surfaces except for the front surface of the upper end portion of the breaker main body 10 are supported by the bracket 60 by a fixing pad 63.

In this regard, the support member assembly 81 is assembled between the stopper 71 positioned at the inner upper end portion of the bracket 60 and the front surface of the breaker main body 10.

That is, in a process of installing the support member assembly 81 at the stopper 71, the closely contacting inclined portion 85 of the fixture 83 descends while sliding along the tapered portion 73 of the stopper 71, and, when the support member assembly 81 does not descend any longer, the support member assembly 81 is closely supported by the stopper 71, and thus the support member assembly 81 does not move leftward or rightward.

When the support member assembly 81 is closely supported by the stopper 71, the head plate 95 is assembled to an upper side of the bracket 60.

In this regard, the head plate 95 pressurizes the movement prevention member 91 of the support member assembly 81 towards the lower part of the bracket 60.

In this manner, assembly of the breaker main body 10 and the bracket 60 is completed, and the support member assembly 81 is fitted between the head plate 95 and the stopper 71, and thus both vertical movement and horizontal movement of the support member assembly 81 are prevented.

Accordingly, the breaker main body 10 is stably supported by the bracket 60, resulting in reduced occurrence of noise during operation and enhanced work efficiency.

As such, according to the present invention, a control valve is provided in a back head of a breaker main body, whereby the control valve may be conveniently replaced, and productivity may be enhanced due to shortened replacement time.

In addition, a bracket has an improved support structure for the breaker main body, and thus the breaker main body is stably supported by the bracket, resulting in reduced occurrence of noise during operation and enhanced work efficiency.

It is obvious to those of ordinary skill in the art that the present invention is not limited to the embodiments described herein, and various changes and modifications may be made without departing from the spirit and scope of the present invention. Thus, such changes or modifications should be construed as being within the scope of the following claims of the present invention.

What is claimed is:

1. A hydraulic breaker comprising a breaker main body comprising:
a back head provided with a gas chamber therein;
a cylinder positioned below the back head and provided with a hydraulic path and a hydraulic space;
a front head positioned below the cylinder;
a chisel installed inside the front head;
a piston reciprocally movably installed in the cylinder so as to strike the chisel; and
a plurality of through bolts connecting the back head to the cylinder to the front head,
wherein the back head of the breaker main body is provided with a control valve to supply hydraulic pressure to the hydraulic path and the hydraulic space and block the supply.

2. The hydraulic breaker according to claim 1,
wherein the cylinder is provided, on an outer side thereof, with an accumulator to smooth flow of a fluid through the hydraulic path.

3. The hydraulic breaker according to claim 1, wherein the hydraulic breaker comprises:
a bracket surrounding and supporting the breaker main body and installed at an excavator, a lower end portion of the breaker main body inserted into the bracket being fixed to the bracket by a fixing member, and three remaining surfaces except for a front surface of an upper end portion of the breaker main body being supported by the bracket by a fixing pad;
a stopper provided at an inner upper end portion of the bracket facing the front surface of the breaker main body and having a tapered portion where a distance between the front surface of the breaker main body and an inside of the bracket gradually decreases towards a lower end portion of the bracket; and
a support member assembly having a closely contacting inclined portion that closely contacts the tapered portion and disposed between the stopper and the front surface of the breaker main body to support the front surface of the upper end portion of the breaker main body on the inside of the bracket.

4. The hydraulic breaker according to claim 3,
wherein the support member assembly comprises: a fixture provided with the closely contacting inclined portion closely contacting the tapered portion, an insertion hole formed in a plate surface thereof facing the front surface of the breaker main body, and a fixing pin protruding from an upper portion thereof, and inserted between the stopper and the front surface of the breaker main body; a movement prevention member fitted into and coupled to the fixing pin to prevent vertical movement; and a shock absorption pad inserted into and coupled to the insertion hole to absorb shock.
